(19) United States
(12) Patent Application Publication
(10) Pub. No.: US 2005/0249491 A1
(43) Pub. Date: Nov. 10, 2005

(54) Device with retractable viewfinder and method using the same

(76) Inventors: Jih-Yung Lu, Taipei County (TW); Hsuan-Chang Lu, Tainan City (TW)

Correspondence Address: BIRCH STEWART KOLASCH & BIRCH, PO BOX 747, FALLS CHURCH, VA, 22040-0747, US

(21) Appl. No.: 11/119,764

(22) Filed: May 3, 2005

(30) Foreign Application Priority Data
May 5, 2004 (TW) 93112622

(51) Int. Cl. G03B 15/02

(52) U.S. Cl. 396/373

(57) ABSTRACT

A device with a viewfinder and a method using the same are disclosed. The device includes a body, a viewfinder and a linking mechanism. The viewfinder is rotatably connected to the body of the device. The viewfinder rotates between a retracted position and an extended position. The linking mechanism is connected to and rotates the viewfinder.

### BACKGROUND

The invention relates to a device, and more particularly, to a device with a retractable viewfinder.

A device such as a digital camera shown in FIG. 1 comprises a body 11 and a conventional viewfinder 12. The viewfinder 12 comprises a plurality of lenses fixed on the body 11. Digital cameras normally comprise an LCD display more frequently used than the conventional viewfinder, which is normally only used when battery power is low, such that space occupied by the viewfinder is wasted most of the time.

It is therefore desirable to provide a retractable viewfinder to further reduce occupied space in the device.

### SUMMARY

Accordingly, a device is disclosed comprising a body, a viewfinder, and a linking mechanism. The viewfinder is rotatably connected to the body. The viewfinder may rotate between a retracted position and an extended position. The linking mechanism is connected to and rotates the viewfinder.

Embodiments of the invention further comprise a driving mechanism connected to and driving the linking mechanism. The driving mechanism may be a pushrod or button.

### BRIEF DESCRIPTION OF THE DRAWINGS

The invention can be more fully understood by reading the subsequent detailed description in conjunction with the examples and references made to the accompanying drawings, wherein:

FIG. 1 is a schematic diagram of a conventional camera;

FIG. 2A is a schematic diagram of a device of a first embodiment of the invention, with the retractable viewfinder in a retracted position;

FIG. 2B is a side view of FIG. 2A;

FIG. 2C is another schematic diagram of the device of the first embodiment, with the retractable viewfinder in an extended position;

FIG. 2D is a side view of FIG. 2C;

FIG. 3A is a schematic diagram of a device of a second embodiment of the invention;

FIG. 3B is a side view of FIG. 3A;

FIG. 3C is another schematic diagram of the device of the second embodiment;

FIG. 3D is a side view of FIG. 3C;

FIG. 4A is a schematic diagram of a device of a third embodiment of the invention;

FIG. 4B is another schematic diagram of the device of the third embodiment;

FIG. 5 is a skeleton diagram of a device of a fourth embodiment of the invention; and

FIG. 6 is a skeleton diagram of a device of a fifth embodiment of the invention.

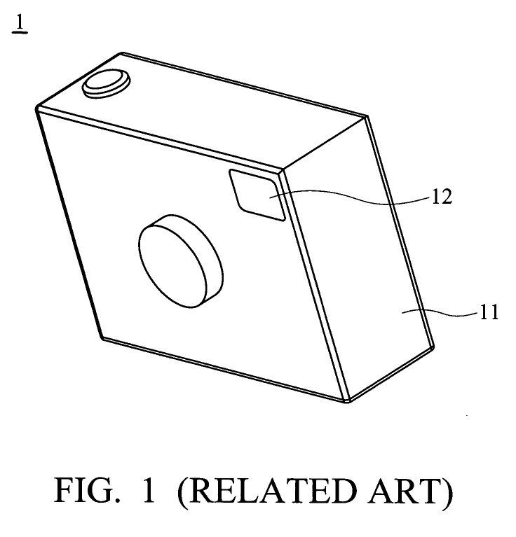

### DETAILED DESCRIPTION

### First Embodiment

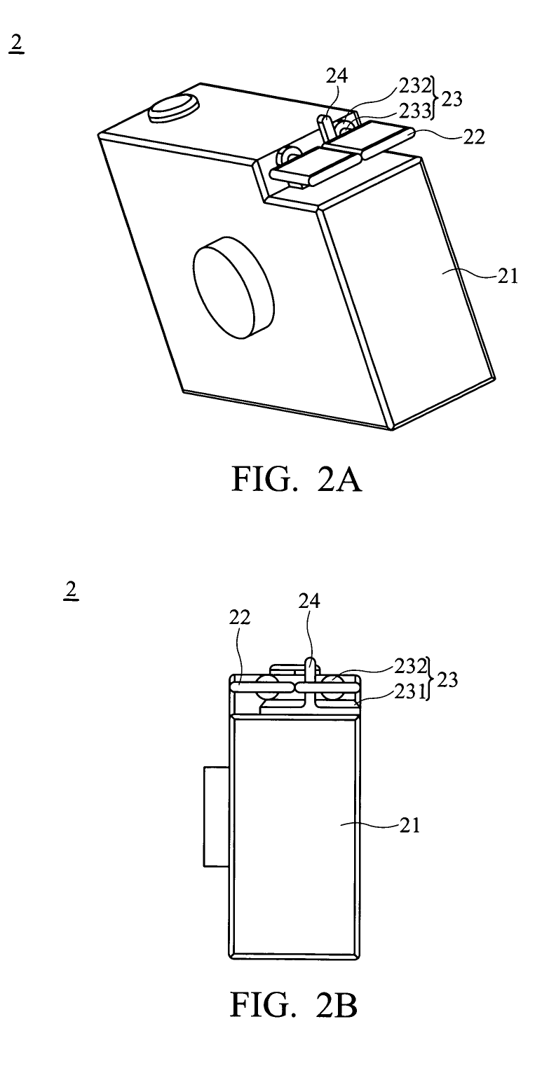

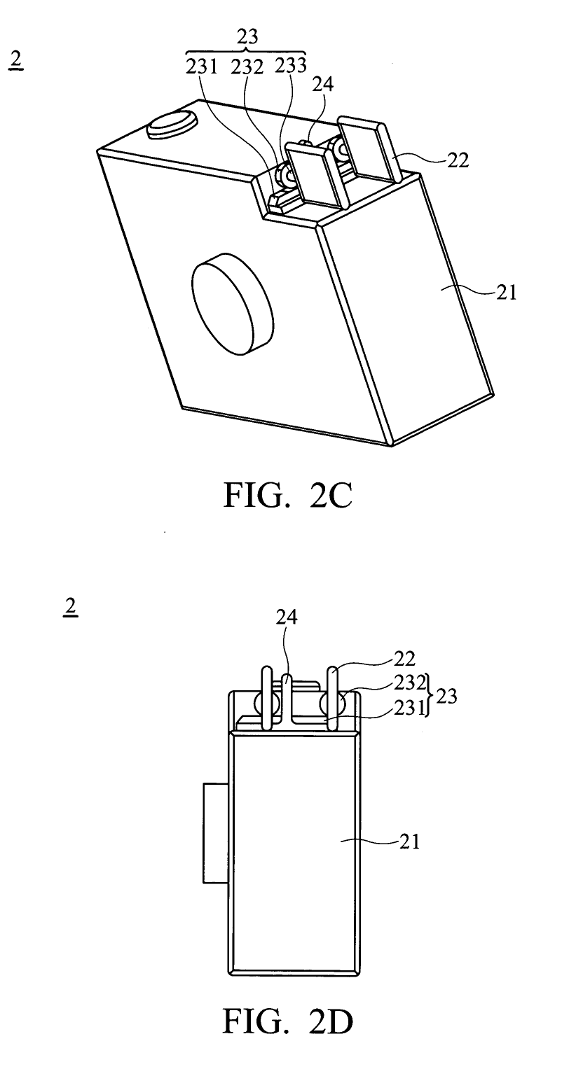

FIGS. 2A to 2D show a first embodiment of a device of the invention. The device 2 comprises a body 21, a viewfinder 22, a linking mechanism 23, and a driving mechanism. In this embodiment, the driving mechanism is a pushrod 24. The linking mechanism 23 connects the viewfinder 22 and the body 21, and the pushrod 24 connects and drives the linking mechanism 23, such that the viewfinder 22 rotates between a retracted position and an extended position. In this embodiment, device 2 may be a camera, and the viewfinder 22 may comprise one, two, or several lenses.

The linking mechanism 23 comprises a first rack 231, a first gear 232, and a rotating shaft 233. The first rack 231 connects to the pushrod 24, the first gear 232 engages the first rack 231, and the rotating shaft 233 connects the viewfinder 22 and the first gear 232. Thus, when the pushrod 24 is operated, the first rack 231 moves therewith, and the first gear 232, the rotating shaft 233, and the viewfinder 22 are rotated, sequentially.

FIG. 2A shows the device 2 before the pushrod 24 is engaged, with the viewfinder 22 in retracted position. FIG. 2C shows the device 2 after the pushrod 24 has been engaged, with the viewfinder 22 in extended position.

### Second Embodiment

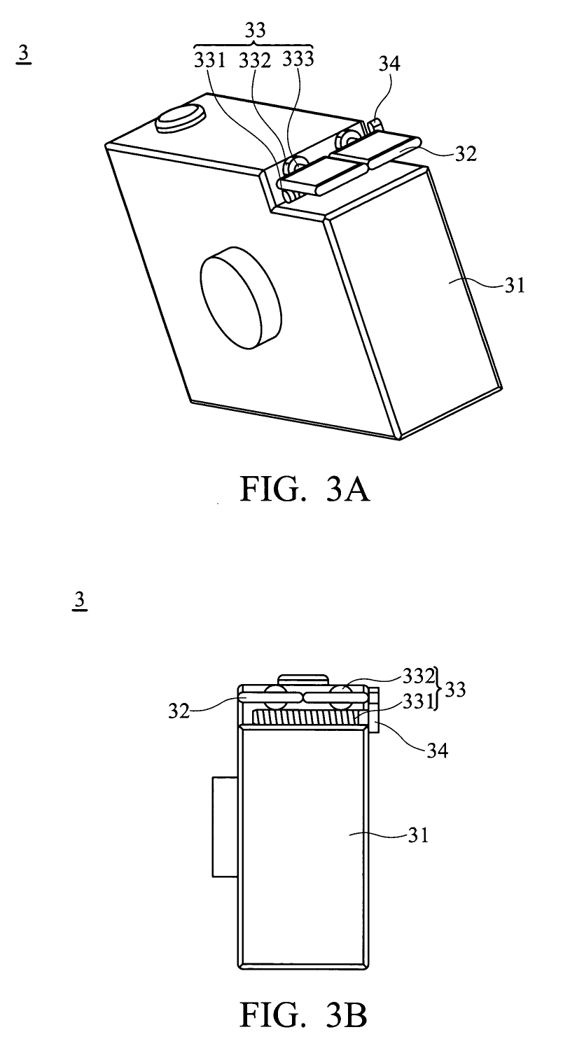

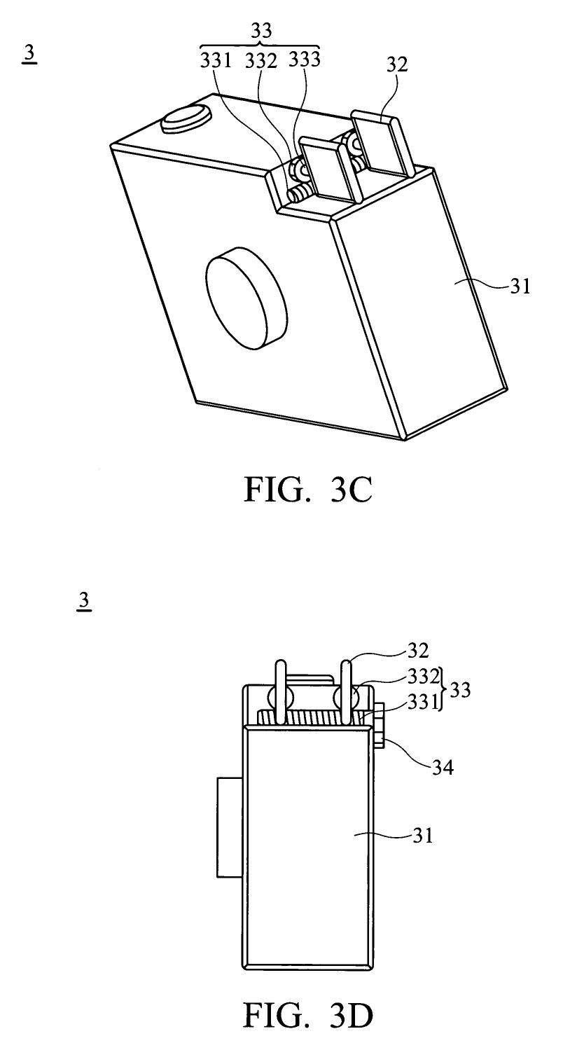

FIGS. 3A to 3D show a second embodiment of a device of the invention. The device 3 comprises a body 31, a viewfinder 32, a linking mechanism 33, and a driving mechanism. In this embodiment, the driving mechanism is a button 34. The linking mechanism 33 connects the viewfinder 32 and the body 31, and the button 34 connects and drives the linking mechanism 33, such that the viewfinder 32 rotates between a retracted position and an extended position. In this embodiment, device 3 may be a camera, and the viewfinder 32 may comprise one, two, or several lenses.

The linking mechanism 33 comprises a first worm shaft 331, a first worm gear 332, and a rotating shaft 333. The first worm shaft 331 connects to the button 34, the first worm gear 332 engages the first worm shaft 331, and the rotating shaft 333 connects the viewfinder 32 and the first worm gear 332. Thus, when the button 34 is rotated, the first worm shaft 331, the first worm gear 332, the rotating shaft 333, and the viewfinder 32 are rotated, sequentially.

FIG. 3A shows the device 3 before rotation of the button 34, with the viewfinder 32 in retracted position. FIG. 3C shows the device 3 after the button 34 is rotated, with the viewfinder 32 in extended position.

### Third Embodiment

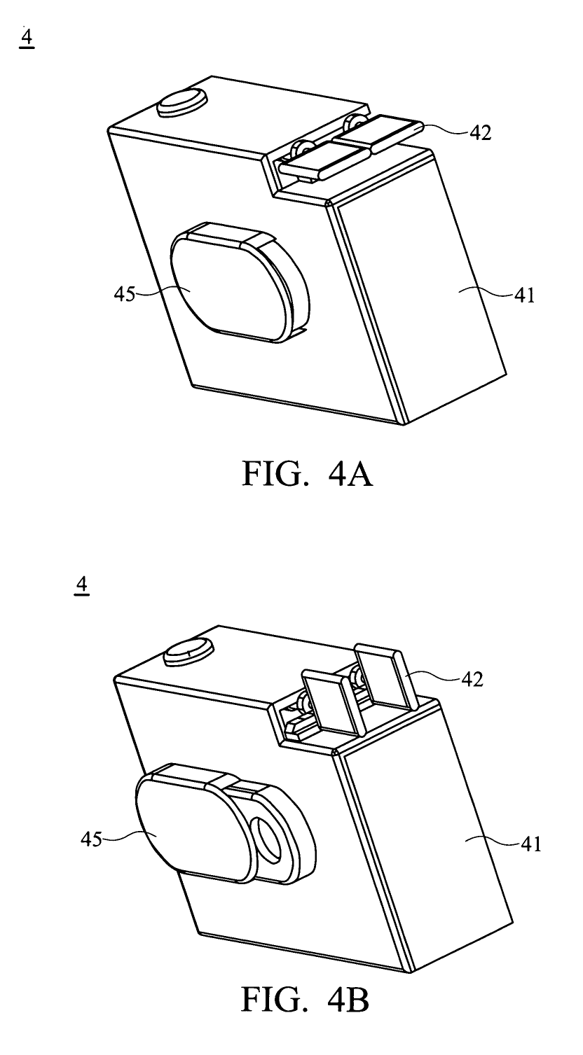

FIGS. 4A and 4B show a third embodiment of a device of the invention. The device 4 comprises a body 41, a viewfinder 42, a linking mechanism, a driving mechanism, and a switch. In this embodiment, the device may be a camera, and the switch is a lens cover 45 for a lens of the camera. Move the lens cover 45 can drive the whole mechanism, and thus the viewfinder 42 rotates between a retracted position and an extended position. FIG. 4A shows the lens cover 45 covering the lens and the viewfinder 42 in the retracted position. FIG. 4B shows the lens cover 45 open and the viewfinder 42 in the extended position. The linking mechanism is not shown in this embodiment, being identical to that in the first and second embodiments.

### Fourth Embodiment

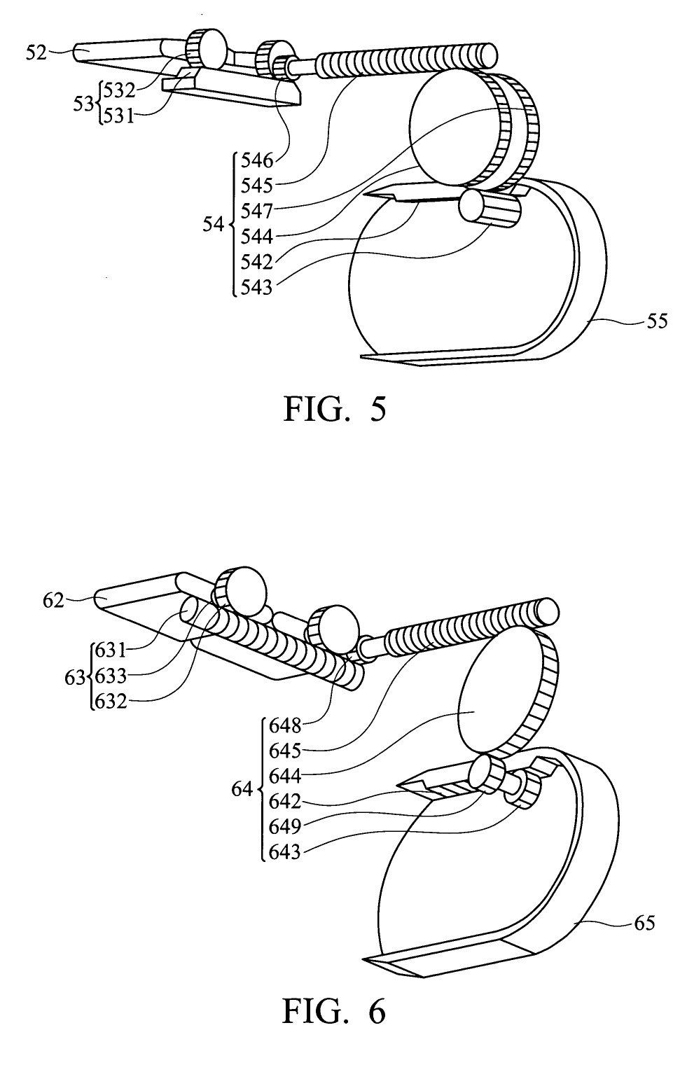

FIG. 5 shows inner structures of a fourth embodiment of a device of the invention. The device comprises a body (not shown), a viewfinder 52, a linking mechanism 53, a driving mechanism 54, and a switch 55. The linking mechanism 53 connects the viewfinder 52 and the body. The driving mechanism 54 is disposed inside the body, connecting the linking mechanism 53 and the switch 55. Thus, the viewfinder 52 rotates between a retracted position and an extended position by the switch 55 acting with the driving mechanism 54 and the linking mechanism 53.

The linking mechanism 53 in this embodiment is similar to the first embodiment, and is thus omitted.

In this embodiment, the driving mechanism 54 comprises a second rack 542, a second gear 543, a second worm gear 544, a second worm shaft 545, a third gear 546, and a fourth gear 547. The second rack 542 is disposed on the switch 55. The second gear 543 engages the second rack 542, the fourth gear 547 engages the second gear 543, the second worm gear 544 and the fourth gear 547 are coaxial, the second worm shaft 545 engages the second worm gear 544, and the third gear 546 is disposed at an end of the second worm shaft 545 and engages the first rack 531 of the linking mechanism 53.

When the switch 55 is operated, the second rack 542 thereon rotates the second gear 543, and the fourth gear 547 rotates therewith. Since the second worm gear 544 and the fourth gear 547 are coaxial, the second worm gear 544 rotates together with the fourth gear 547. The second worm gear 544 rotates the second worm shaft 545, and the third gear 546, connected to the second worm shaft 545, rotates therewith, such that the third gear 546 drives the linking mechanism 53.

When operated, the switch 55 drives the driving mechanism 54 and linking mechanism 53 sequentially, such that the viewfinder 52 rotates between the retracted position and the extended position.

### Fifth Embodiment

FIG. 6 shows inner structures of a fifth embodiment of a device of the invention. The device comprises a body (not shown), a viewfinder 62, a linking mechanism 63, a driving mechanism 64, and a switch 65. The linking mechanism 63 connects the viewfinder 62 and the body. The driving mechanism 64 is disposed inside the body, connecting the linking mechanism 63 and the switch 65. Thus, the viewfinder 62 rotates between a retracted position and an extended position by the switch 65 acting with the driving mechanism 64 and the linking mechanism 63.

The linking mechanism 63 in this embodiment is similar to the second embodiment, and is thus omitted.

In this embodiment, the driving mechanism 64 comprises a second rack 642, a second gear 643, a second worm gear 644, a second worm shaft 645, a third worm gear 648, and a fifth gear 649. The second rack 642 is disposed on the switch 65. The second gear 643 engages the second rack 642, and since the fifth gear 649 and the second gear 643 are coaxial, the second worm gear 644 engages the fifth gear 649, the second worm shaft 645 engages the second worm gear 644, and the third worm gear 648, disposed at an end of the second worm shaft 645, engages the first worm shaft 631 of the linking mechanism 63.

When the switch 65 is operated, the second rack 642 thereon rotates the second gear 643. Since the fifth gear 649 and the second gear 643 are coaxial, the fifth gear 649 rotates with the second gear 643. The fifth gear 649 rotates the second worm gear 644, and the second worm gear 644 rotates the second worm shaft 645, and the third worm gear 648, connected to the second worm shaft 645, rotates therewith, such that the third worm gear 648 drives the linking mechanism 63. In this embodiment, the fifth gear 649 is helical.

Operating the switch 65 can turn on or off the device. When operated, the switch 65 drives the driving mechanism 64 and linking mechanism 63 sequentially, such that the viewfinder 62 rotates between the retracted position and the extended position.

The linking mechanism and the driving mechanism mentioned can vary according to different requirements. The combination of the linking and the driving mechanisms can alternatively be applied in a device with a retractable viewfinder.

While the invention has been described by way of example and in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A device, comprising:
a body;
a viewfinder rotatably connected to the body, rotatable between a retracted position and an extended position; and
a linking mechanism connected to and rotating the viewfinder.

2. The device as claimed in claim 1, further comprising a driving mechanism connected to and driving the linking mechanism.

3. The device as claimed in claim 2, wherein the driving mechanism comprises a pushrod.

4. The device as claimed in claim 3, wherein the linking mechanism comprises a first rack and a first gear, with the first rack connected to the pushrod, the first gear engaging the first rack, and, when the pushrod moves the first rack, the first gear rotates therewith, and the viewfinder is rotated.

5. The device as claimed in claim 4, wherein the linking mechanism further comprises a rotating shaft connected to the viewfinder and to the first gear so that the viewfinder rotates therewith.

6. The device as claimed in claim 2, wherein the driving mechanism comprises a button.

7. The device as claimed in claim 6, wherein the linking mechanism comprises a first worm shaft and a first worm gear, with the first worm shaft connected to the button and the first worm gear engaging the first worm shaft, such that when the button rotates, moving the first worm shaft, the first worm gear rotates therewith, and the viewfinder is rotated.

8. The device as claimed in claim 7, wherein the linking mechanism further comprises a rotating shaft connecting the viewfinder and to the first worm gear such that the viewfinder rotates therewith.

9. The device as claimed in claim 2, wherein the driving mechanism comprises:
a second rack;
a second gear engaging the second rack and rotating therewith;
a second worm gear engaging the second gear and rotating therewith; and
a second worm shaft connecting the second worm gear and the linking mechanism and rotating with the second worm gear to drive the linking mechanism.

10. The device as claimed in claim 9, wherein the driving mechanism further comprises a third gear and the linking mechanism comprises a first rack and a first gear, the third gear disposed on one end of the second worm shaft and engaging the first rack, the first rack engaging the first gear, and the first gear connected to the viewfinder, such that when the second worm shaft is rotated, the third gear rotates, the first rack moves, and the first gear rotates, such that the viewfinder is rotated.

11. The device as claimed in claim 9, wherein the driving mechanism further comprises a fourth gear connected to the second worm gear and engaging the second gear such that the fourth gear and the second worm gear rotate therewith.

12. The device as claimed in claim 11, wherein the second worm gear and the fourth gear are coaxial.

13. The device as claimed in claim 9, wherein the driving mechanism further comprises a third worm gear and the linking mechanism comprises a first worm shaft and a first worm gear, the third worm gear disposed on one end of the second worm shaft engages the first worm shaft, the first worm shaft engages the first worm gear, and the first worm gear is connected to the viewfinder, such that when the second worm shaft is rotated, the third worm gear, the first worm shaft, and the first worm gear rotate sequentially, such that the viewfinder is rotated.

14. The device as claimed in claim 9, wherein the driving mechanism further comprises a fifth gear connected to the second gear and engaging the second worm gear so that the fifth gear and the second worm gear rotate therewith.

15. The device as claimed in claim 14, wherein the second gear and the fifth gear are coaxial.

16. The device as claimed in claim 14, wherein the fifth gear is helical.

17. The device as claimed in claim 2, further comprising a switch connected to and driving the driving mechanism.

18. The device as claimed in claim 17, wherein the switch comprises a lens cover, when the lens cover is pushed open or closed, the lens cover drives the driving mechanism, the linking mechanism, and the viewfinder.

19. The device as claimed in claim 17, wherein the device comprises a camera.

20. The device as claimed in claim 17, wherein the viewfinder comprises a lens.

21. A device, comprising:
a viewfinder, comprising a lens rotating between a retracted position and an extended position; and
a linking mechanism connected to and driving the viewfinder to rotate.

22. The device as claimed in claim 21, wherein the viewfinder further comprises a rotating shaft engaging the lens, rotatably connected to the linking mechanism such that the lens rotates therewith.

23. A method of using a retractable viewfinder, comprising:
providing a viewfinder which is rotatable between a retracted position and an extended position; and
pulling a linking mechanism which is connected to the viewfinder, to make the viewfinder rotate.

24. The method as claimed in claim 23, the viewfinder being connected to a device, the method further comprising: turning on the device to drive the linking mechanism to rotate the viewfinder to the extended position.

25. The method as claimed in claim 24, further comprising turning off the device to drive the linking mechanism to rotate the viewfinder to the retracted position.
